(19) United States
(12) Patent Application Publication
(10) Pub. No.: US 2008/0048463 A1
(43) Pub. Date: Feb. 28, 2008

(54) Dog waste collection device

(76) Inventors: Albert Andrew Selenke, Denver, OH (US); William Michael Selenke, Cincinnati, OH (US)

Correspondence Address: William M. Selenke, 5 Drummond St., Cincinnati, OH, 45218, US

(21) Appl. No.: 11/581,237

(22) Filed: Oct. 16, 2006

Related U.S. Application Data
(60) Provisional application No. 60/737,578, filed on Nov. 18, 2005.

(51) Int. Cl. A01K 29/00

(52) U.S. Cl. 294/1.3

(57) ABSTRACT

The invention is a bag-scoop device to collect dog waste. The scoop part is a flat construct which readily folds and squeezes into a disposable scoop or shovel. The manufactured invention includes a bag that contains the scoop and attached frame. The frame holds the bag open to receive the feces. The frame automatically is placed in the opening of the bag as the scoop is removed. In a second option a scraper part is attached to the scoop.

### FIELD OF INVENTION

The invention is concerned with devices that aid the gathering, picking up, and the safe sequestering of noxious waste, especially dog waste. More particularly the invention is concerned with devices that are easily carried and easy to use. In particular, it is concerned with devices that can be used to remove dog waste. The inventive device properly used will minimize contact with the waste. Likewise, the invention may be used in isolated areas to gather human waste or other semi-solid fluids that need transported and disposed. As a modification for hiking and outdoor use, the present invention may have gloves and toilet paper in the kit.

### BACKGROUND OF INVENTION

The production of waste or feces by animals is an essential part of nature. In the wild, animal feces with the aid of dung beetles is rapidly broken down and becomes part of a natural fertilizer of nature. In many respects modern cities with their sidewalks, streets, and walkways are not environmentally natural. This is especially true in cities with large numbers of animals in limited spaces. For this reason pet owners who are walking their dogs are required in many cities and places to remove the feces that their canine produces. The waste of an occasional dog would create a minor nuisance in a crowded city. However, dozens or hundreds of dogs change a minor nuisance into a public health and aesthetic problem.

Because the problem of uncollected dog feces is immediate and noticeable there have been dozens of devices in the patent literature that teach the picking up and disposal of canine feces. A common device is one that is made from a flat strip of material such as plastic or paper that can be folded into a sanitary scoop. Such examples are: D328, 809; D334,638; U.S. Pat. Nos. 5,865,486; 1,106,282; 5,865,486; and 5,878,461. While these various devices may be useful, they of themselves when used may allow the ready touching of the human hand to the dog feces.

The present invention likewise has other uses. For example, police and other public patrols might desire a larger version of the present invention to pick up small dead animals and other unknown or hazardous substances. Likewise since the present invention is light and compact it can be used in outdoor hiking situations if needed to transport human feces to a safe disposal site. In these embodiments gloves and/or a hand wipe can be incorporated as part of the kit.

### SUMMARY OF INVENTION

The invention is a scoop device to collect and sequester dog waste. The scoop has a dish part and a handle composite. The handle composite is subdivided with upward foldable right handle support with a right crease to make a right center support and right outer support. It also has an upward foldable left handle support with a left crease to make a left center support and a left outer support. The right center support, left center support, right outer support, and left outer support are each about one-fourth the width of the handle composite. Midway between right shovel handle support and left shovel handle support is a handle groove that allows downward bends for left center support and right center support.

The handle groove extends to about one-third to one-half of scoop part and continues as a right bifurcation bend and left bifurcation bend. Right bifurcation bend and left bifurcation bend are at obtuse angles and connect to the right crease line and left crease line as an angle point. The right handle support continues to become right dish side and the left handle support continues to become left dish side. The right crease bend and the left crease bend makes a right dish shoulder and a left dish shoulder. The right bifurcation bend and the left bifurcation bend in cooperation with a kite shaped portion created in part by right bifurcation bend and left bifurcation bend provide a top wall of the dish part. The right dish shoulder, left dish shoulder, a kite shaped portion, right dish side and left dish side provide walls for dish base. The inventive scoop device has an optional scraper part that is attached with a fold to the dish base.

An alternative embodiment of scoop device with bag to collect and sequester dog waste is made up of a scoop part and a bag box part. The scoop part comprises a dish part and a handle composite. That handle composite is subdivided with upward foldable right handle support with a right crease and an upward foldable left handle support with a left crease. The handle composite has a right center support and a left center support. The right crease, left crease, right center support, and left center support are each about one-fourth the width of the handle composite. Midway between the right handle support and left handle support is a handle groove that allows downward bends for the left center support and the right center support. The handle groove extends to about one-third to one-half of scoop part and continues as a right bifurcation bend and left bifurcation bend to become right crease line and left crease line as an angle point. The right handle support continues to become right dish side and the left handle support continues to become left dish side. The right crease bend, and left crease bend make a right dish shoulder and a left dish shoulder. The right bifurcation bend and left bifurcation bend along with a kite shaped portion created in part by the right bifurcation bend and the left bifurcation bend provide a top wall of the dish part. The right dish shoulder, left dish shoulder, a kite shaped portion, right dish side and left dish side provide walls for dish base.

The dish base is connected with perforations to bag box part. That bag box part has a scraper leaf end and a perforated end and comprises a box holder frame which is connected with perforations to dish segment end of the scoop part. The box holder frame is defined by a bag holder opening door which has a bend line proximal to scraper end. The bag holder opener has a hand slot cut opening. Opposite perforations that connects box holder frame to dish segment end of scoop part is a scraper end leaf that is defined by a bend slash attached to said box holder frame. This scoop device to collect and sequester dog waste includes a closable bag which contains the scoop and bag holder opener combination.

### BRIEF DESCRIPTION OF FIGURES

FIG. 1 shows details of the scoop part of device to collect and sequester dog waste.

FIG. 2 shows a flat semi rigid construct for the collection of dog waste with a bag box part connected with perforations to scoop part. FIG. 3 shows the pattern of folds needed so that flat semi rigid construct can be converted into a scoop. FIG. 4 shows a side views of device partially folded in collection bag. FIG. 5 shows a perspective view of device partially removed from bag. FIG. 6 shows top view of collection bag with access hole. FIG. 7 shows the isolated scoop part as it is being squeezed into a scoop form. FIG. 8 shows isolated scoop part squeezed into the final form for collecting dog feces.

### DETAILED DESCRIPTION OF FIGURES

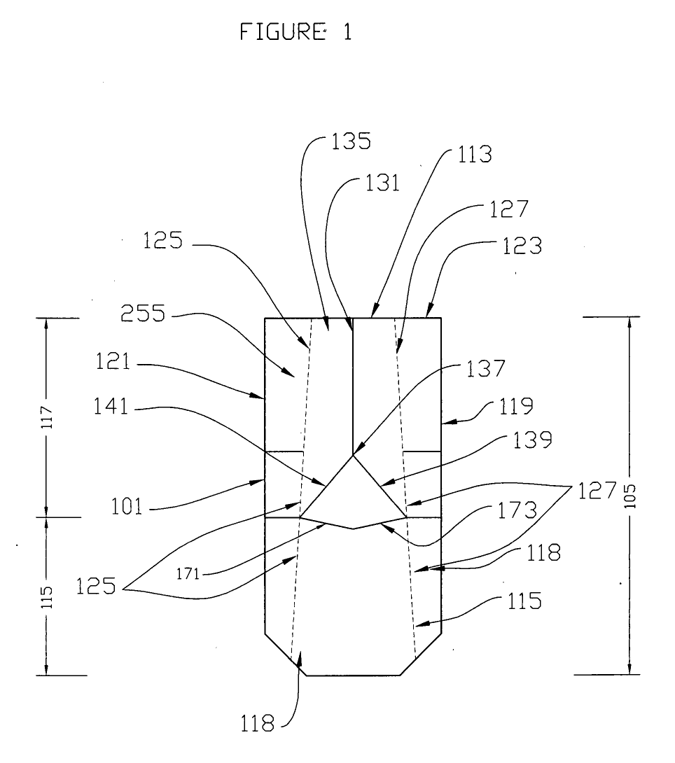

FIG. 1 shows details of the scoop part 105 of the device to collect dog waste. Scoop part 105 has a handle composite 117 and a dish section 115. Dish section 115 has dish base 118. The shovel handle composite 117 has a right handle support 119 and a left handle support 121. Right handle support 119 has a right crease 127 to make a right center support 113 and right outer support 123. Right crease 127 allows a downward bend between right center support 113 and right outer support 123. Left crease 125 allows a downward bend for left center support 135 and left outer support 255.

Midway between right shovel handle section 119 and left shovel handle section 121 is handle groove 131 that allows downward bends for left center support 135 and right center support 113. Handle groove 131 extends to about one-third to one-half of scoop part 105 to end at angle point 137 and continues as a right bifurcation bend 139 and left bifurcation bend 141. Right bifurcation bend 139 and left bifurcation bend 141 are at angles of less than 70° and connect angle point 137 to creases 127 and 125. Right bifurcation bend 139 and left bifurcation bend 141 are matched with left dish top line 171 and right dish top line 173 to create a kite shaped portion 183 that generally bends up. Right handle support 119 continues to become right dish side 433. Left handle support 121 continues to become left dish side 435. Right crease bend 127, left crease bend 125, right dish side 433, and left dish side 435 provides enclosure for dish base 118. Arrows 147 shows the direction of the bend along 125 and 127.

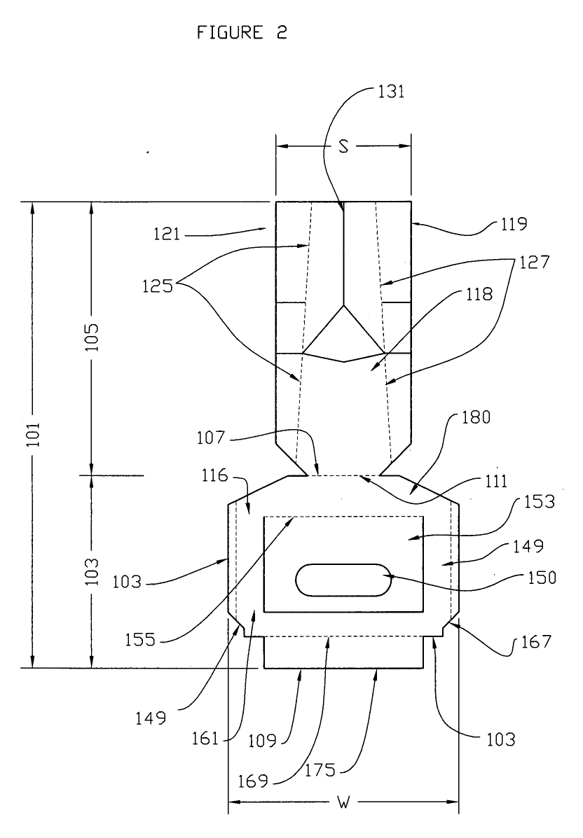

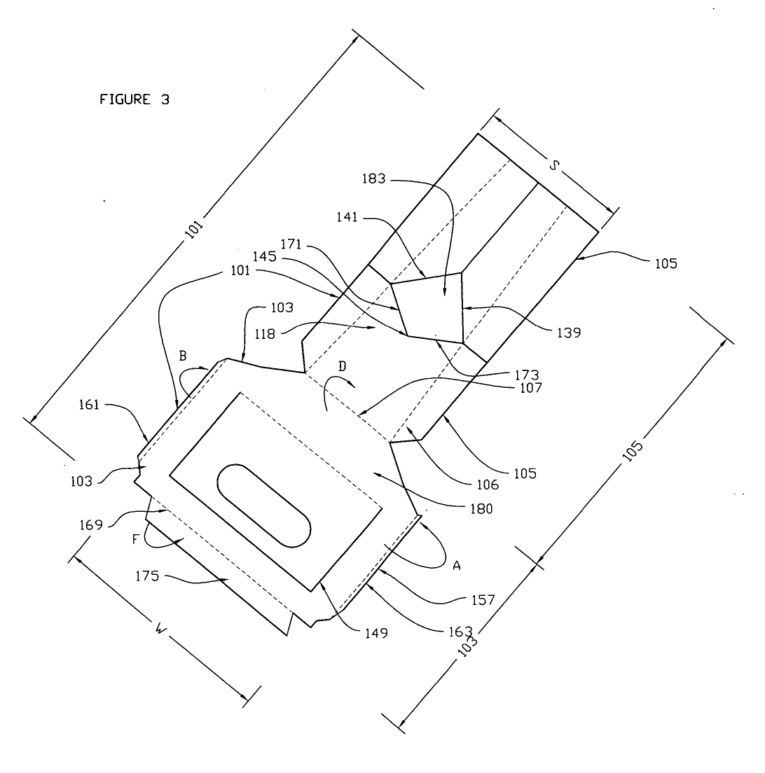

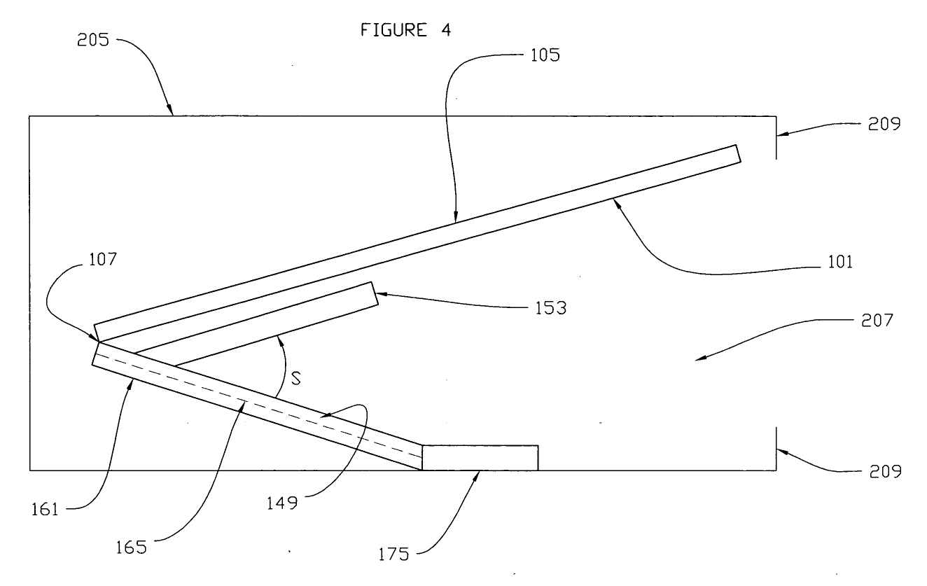

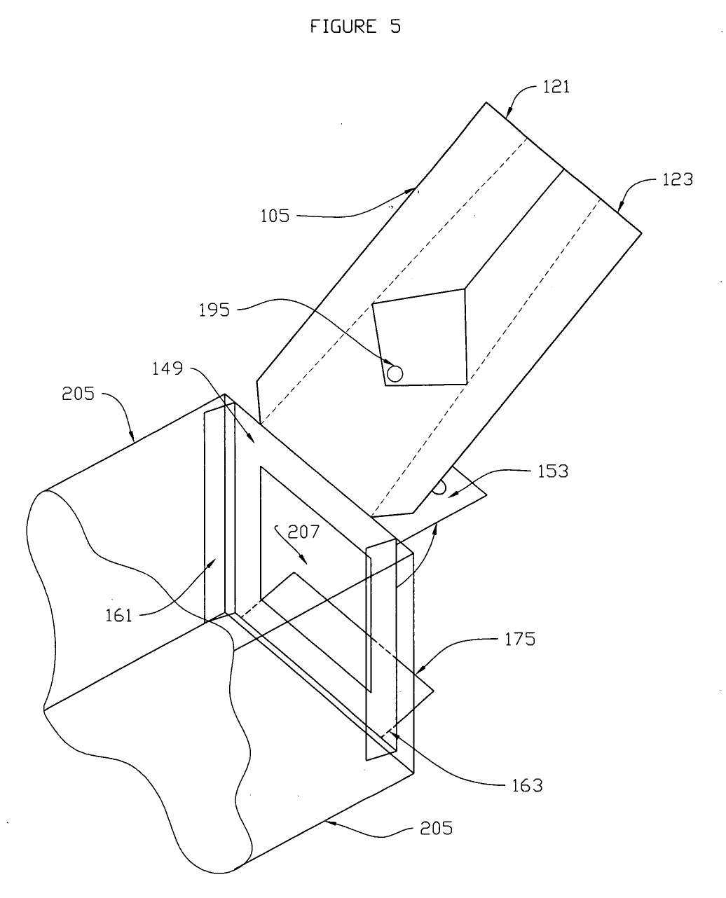

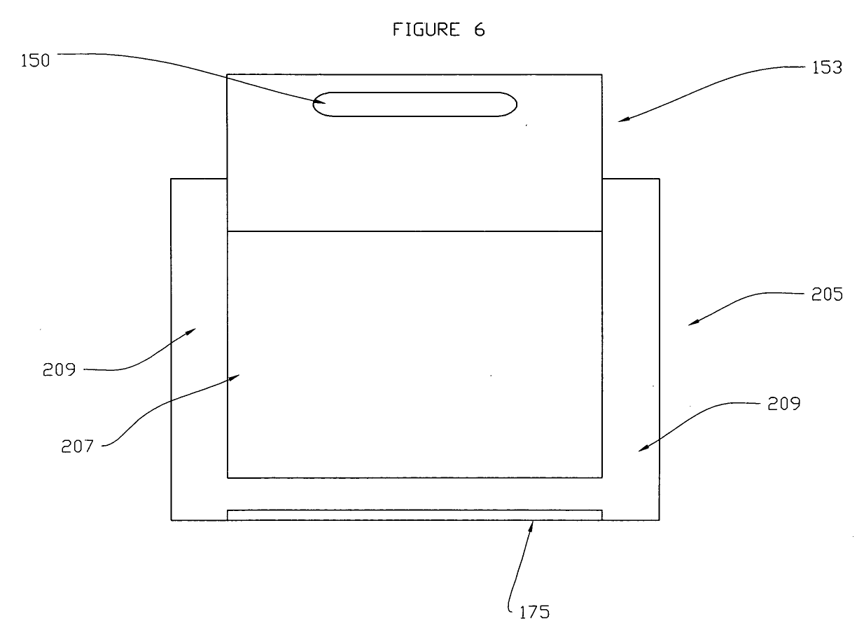

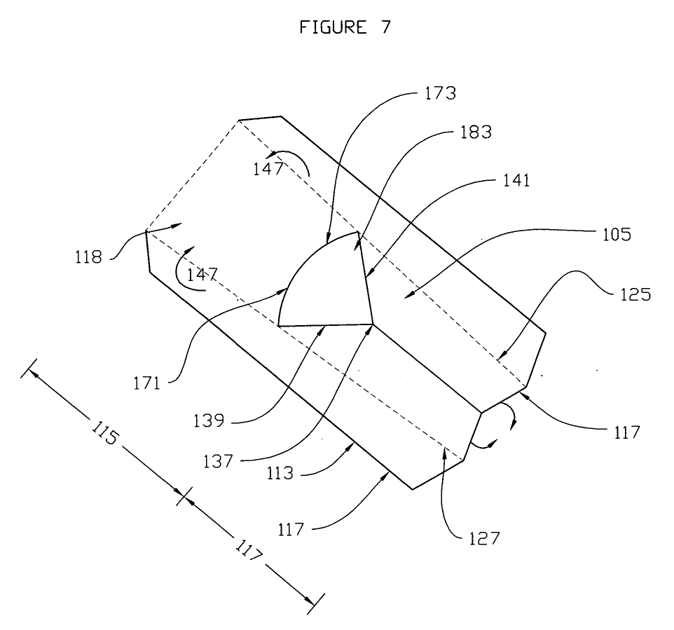

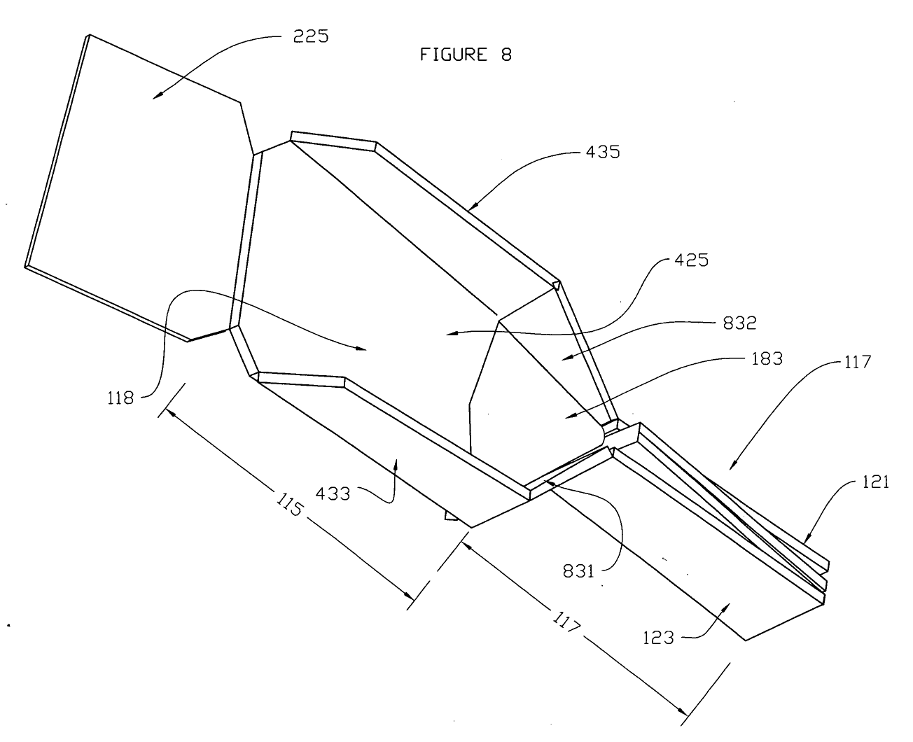

FIG. 2 shows scoop device with bag to collect dog waste as a flat semi rigid construct 101 with a bag box part 103 connected with perforations 107 to scoop part 105. Scoop part 105 is shown in detail in FIG. 1. Bag box part 103 has a scraper end leaf 175 which terminates in scraper end 109. Opposite scraper end 109 is perforated box end 111. Perforated end 111 is attached to top length 180 of box holder frame 149.

Bag box part 103 comprises a box holder frame 149 with a width W. Width W of box holder frame 149 is of a greater width than the width S of scoop part 105 so that box holder frame 149 is retained by bag lip 209 of bag 205 for feces. Perforated end 111 is attached with perforations 107 to top length 180 of box holder frame 149. Bag box part 103 has a scraper end 109 and a perforated end 111. Box holder frame 149 is defined by a bag holder opening door 153 which has bend line 155 which parallels perforated end 111 Bag holder opening door 153 has a hand holder slot cut opening 150.

FIG. 3 shows the pattern of folds for flat semi rigid construct 101 as it is to be placed into the collection bag. Bag box part 103 top length 180 is connected with perforations 107 to scoop part 105. Box holder frame 149 has a left wing 161 and a right wing 163 Left wing 161 and right wing 163 fold downward (arrows A and B) from plane of device. Scraper end leaf 175 is attached to box holder frame 157 through leaf box bend 169. Scraper end leaf 175 is bent in an upward arrow F relative to the plane of box holder frame 157. The scoop part 105 is folded upward (arrow D) from the plane of device 101. Right bifurcation bend 139 and left bifurcation bend 141 are at obtuse angles 147 of about 135° and connect angle point 137 to creases 127 and 125. Right bifurcation bend 139 and left bifurcation bend 141 matched with left dish top line 171 connects with right dish top line 173 to create a kite shaped portion 183 that generally bends up.

FIG. 4 shows a side views of device 105 partially folded in collection bag 205. Shown is bag 205 access hole 207. Access hole 207 is surrounded by bag lip 209. Box holder frame 149 is attached via folding line 165 with a left wing 161. Bag holder opening door 153 is shown opening in an upward angle S relative to box holder frame 149. Scoop part 105 is shown folding on the upper side of the folded construct 101.

FIG. 5 shows a perspective view of device 105 partially removed from bag 205 (shown as cut off). Scraper end leaf 175 extends out of bag access hole 207. Box holder frame 149 has a left wing 161 and a right wing 163. Bag holder opening door 153 is shown. Scoop part 105 had been pulled from bag 205 and is ready to be removed from box holder frame 157 by pulling away from perforations 107. Pressure point 195 aids the folding of the scoop part.

FIG. 6 shows top view of bag 205 with access hole 207. Access hole 207 is surrounded by bag lip 209. Scraper end leaf 175 is shown in outline. Bag holder opening door 153 has a hand holder slot cut opening 150.

FIG. 7 shows the start of converting flat isolated scoop part 105 into a useful dog waste scoop with handle section 117 and dish section 115. Dish base 118 is shown. Right bifurcation bend 139 and left bifurcation bend 141 are at obtuse angles 147 of about 135° and connect angle point 137 to creases 127 and 125. Right bifurcation bend 139 and left bifurcation bend 141 matched with left dish top line 171 connects with right dish top line 173 to create a kite shaped portion 183 (with an optional semi-circular top) that generally bends up.

FIG. 8 shows the isolated scoop part 105 squeezed into the final form for collecting dog waste. Dish section 115 and shovel handle section 117 are shown. Optionally when the scoop part is manufactured without the container the dish section 115 maybe attached with perforation to a scraper part 225. Scraper part 225 can be removed to aid the gathering of dog waste. Right outer support 123 continues to become right dish side 433. Left outer support 121 continues to become left dish side 435. Kite shaped portion 183 with right dish shoulder 831 and left dish shoulder 832 provides the top wall of dish part 115.

We claim:

1) A scoop device to collect and sequester dog waste comprising:
a scoop with a dish part and a handle composite;
said handle composite is subdivided with upward foldable right handle support with a right crease to make a right center support and right outer support;
an upward foldable left handle support with a left crease to make a left center support and a left outer support;
said right center support, said left center support, said right outer support, and said left outer support are each about one-fourth the width of said handle composite;
midway between said right handle support and said left handle support is a handle groove that allows downward bends for said left center support and said right center support;
said handle groove extends to about one-third to one-half of said scoop part and continues as a right bifurcation bend and left bifurcation bend;
said right bifurcation bend and said left bifurcation bend are at obtuse angles and connect to said right crease line and said left crease line as an angle point;
said right handle support continues to become right dish side;
said left handle support continues to become left dish side;
said right crease bend, and said left crease bend makes a right dish shoulder and a left dish shoulder;
said right bifurcation bend and said left bifurcation bend in cooperation with a kite shaped portion created in part by said right bifurcation bend and said left bifurcation bend provide a top wall of said dish part;
said right dish shoulder, said left dish shoulder, a kite shaped portion, said right dish side and said left dish side provide walls for dish base.

2) A scoop device to collect and sequester dog waste as in claim 1) wherein a scraper part is attached with a fold to said dish base.

3) A scoop device with bag to collect and sequester dog waste comprising;
a scope part and a bag box part;
said scoop part comprises a dish part and a handle composite;
said handle composite is subdivided with upward foldable right handle support with a right crease and an upward foldable left handle support with a left crease;
a right center support and a left center support;
said right crease, said left crease, said right center support, and said left center support;
are each about one-fourth the width of said handle composite;
midway between said right handle support and said left handle support is a handle groove that allows downward bends for said left center support and said right center support;
said handle groove extends to about one-third to one-half of said scoop part and continues as a right bifurcation bend and left bifurcation bend to said right crease line and said left crease line as an angle point;
said right handle support continues to become right dish side;
said left handle support continues to become left dish side;
said right crease bend, and said left crease bend makes a right dish shoulder and a left dish shoulder;
said right bifurcation bend and said left bifurcation bend along with a kite shaped portion created in part by said right bifurcation bend and said left bifurcation bend provide a top wall of said dish part;
said right dish shoulder, said left dish shoulder, a kite shaped portion, said right dish side and said left dish side provide walls for dish base;
said dish base is connected with perforations to preformatted end of bag box part;
said bag box part has a scraper leaf end and a perforated end;
said bag box part comprises a box holder frame said frame is connected with perforations to said dish segment end of said scoop part;
said box holder frame is defined by a bag holder opening door which has a bend line proximal to said box part scraper end with perforations;
said bag holder opener has a hand slot cut opening;
opposite said perforations that connects said box holder frame to said dish segment end of said scoop part is a scraper end leaf that is defined by a bend slash attached to said box holder frame.

4) A scoop device with bag to collect and sequester dog waste as in claim 3) further comprising a closable bag which-contains said scoop and said bag holder opener.
